(19) United States
(12) Patent Application Publication
(10) Pub. No.: US 2005/0037120 A1
(43) Pub. Date: Feb. 17, 2005

(54) Method for cooking meat foodstuffs

(76) Inventor: Yann De Kock, De Haan (BE)

Correspondence Address: MERCHANT & GOULD PC, P.O. BOX 2903, MINNEAPOLIS, MN, 55402-0903, US

(21) Appl. No.: 10/875,593

(22) Filed: Jun. 23, 2004

(30) Foreign Application Priority Data
Feb. 1, 2002 (EP) 1 321 044

(51) Int. Cl. A23G 1/00

(52) U.S. Cl. 426/523

(57) ABSTRACT

The invention relates to a method for continuously cooking meat foodstuffs, wherein said meat foodstuffs circulate in a tunnel furnace on a conveyor belt or on conveying rolls or rollers, which is characterized in that the meat foodstuffs are subjected to the action of a metallic fibre membrane burner of the MFB type.

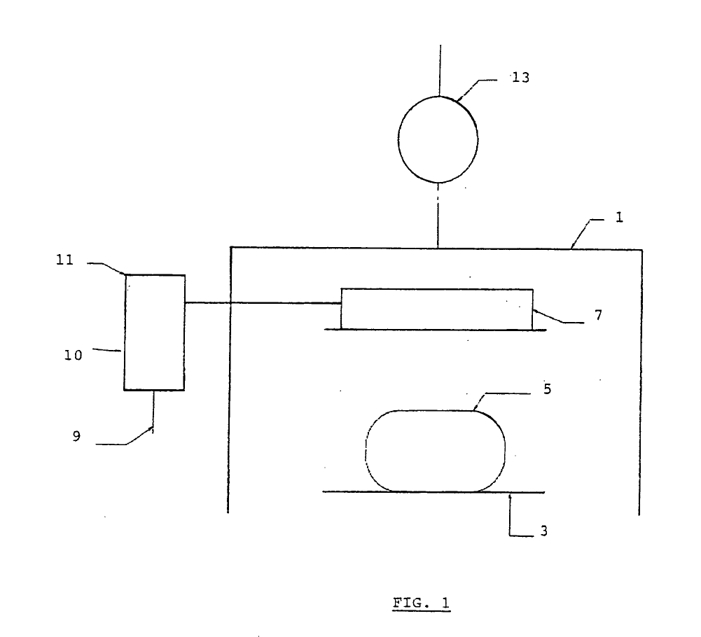

The facility required for implementing the method schematically illustrated in FIG. 1 essentially comprises a tunnel furnace equipped with a conveyor belt or the like, provided with an inlet for the foodstuffs to be cooked at the front and, at the back, with an outlet for such foodstuff after cooking. At least one burner and preferably several successive burners of the MFB type equipped with a thermal control are arranged in the tunnel furnace.

### OBJECT OF THE INVENTION

The present invention relates to an improved method for cooking meat foodstuffs in conditions, which reduce the water loss, and maintain and even increase their flavour.

### TECHNICAL BACKGROUND

Most raw meat foodstuffs, whether preliminarily converted or not, i.e. minced, ground, etc., which are industrially “processed”, are to be subjected to a cooking step. The term is to be understood in the broad sense, i.e., as meaning being subjected to the action of heat.

The industrial techniques are not basically different from the domestic techniques, but are often adapted to a quick processing of the material. To this end, infra-red ovens are widely used in the industry. As is required at the domestic level, according to the circumstances, meat should either be sealed, grilled and/or subjected to a more or less extended cooking step for industrial facilities. In the case of industrial cooking steps, meat foodstuffs possibly have to be medium cooked in order to ensure preserving.

It has, however, been observed that most meat preparations comprise a comparatively significant water content which evaporates upon the cooking process.

Such water losses, which have been considered inevitable until now, yet result in a series of consequences at the organoleptic level, experienced by the consumer as notions such as sapidity, unctuousness, mouth dryness, etc. Such water losses should consequently be reduced.

### AIMS OF THE INVENTION

The invention essentially aims at providing a method, which does not bring about the disadvantages associated to existing techniques. It aims more particularly at maintaining the organoleptic and nutritional properties while reducing water evaporation during cooking.

### STATE OF THE ART

Numerous cooking devices have been used, such as microwave ovens, infrared ovens, ceramic hobs, etc.

On the other hand, more particularly from WO 01/179756, WO 01/179757, WO 01/179758, as well as WO 95/27871 and WO 93/18342, gas burners and, more specifically, sintered metal fibre membranes or hobs suitable for such gas burners are known, whose essential advantage is that they are cheaper to use than electric systems. Such facilities are known under the term MFB (Metal Fibre Burner) and are widely used in various industries, more particularly for drying in the paper industry.

A priori, however, nothing either indicated or allowed to assume that the difficulties in modifying the organoleptic properties, in particular in those modifications resulting from the water losses in meat materials upon cooking encountered until now, could be overcome using burners of the MFB type.

The invention will be further described referring to preferred embodiments of the invention that are given by way of illustration without any limitative character referring to the examples.

### BRIEF DESCRIPTION OF THE ACCOMPANYING DRAWING

The invention will be described hereinafter by way of illustration referring to a sectional schematic view of a facility according to the invention.

### MAIN FEATURES OF THE INVENTION

The invention relates to a method for continuously cooking meat foodstuffs, wherein said meat foodstuffs are conveyed in a tunnel furnace on a conveyor belt or on conveying rolls or rollers, characterized in that the meat foodstuffs are subjected to the action of a metallic fibre membrane burner of the MFB type.

According to such operating mode it is clear that not only satisfactory, or even improved, organoleptic properties are obtained, but that the weight losses due to evaporation are also reduced.

In addition, such effects are reached while maintaining the other intrinsic advantages of burners of such a type, more particularly reduced running costs, a specially long life and an emission spectrum compatible with the absorption spectrum of meat foodstuffs. Additionally, such type of burners emits very little gas of the CO and NOₓ type.

Such a type of burners also allows to easily build such continuous cooking furnaces intended for meat foodstuffs, since the special shape of the burner can be easily adapted to the geometry of the tunnel furnace and more particularly, to conveyor belts or similar, with which cooking tunnel furnaces in the food industry are usually equipped.

Such a type of burner also enables an easy temperature setting through the whole path in the tunnel furnace, so as to be able to seal, grill, roast, medium cook, etc. according to the requirements and following an adequate chronological order adaptable for industrial requirements.

Such a type of burner is particularly adapted for processing meat materials as it allows avoiding staining or polluting of products to be processed while ensuring respect for hygienic criteria.

The facility required for implementing the method as schematically illustrated in FIG. 1 essentially comprises a tunnel furnace equipped with a conveyor belt 3 or the like provided with an inlet for the foodstuffs 3 to be cooked at the front and with an outlet for such foodstuffs after cooking at the back. In the tunnel furnace 1 at least one burner 7 and preferably several successive burners of the MFB type equipped with a thermal control are arranged. As the conveyor belt 3 is in principle circulating at a constant speed, maintaining it at a temperature as imposed by a burner 7 depends on the residence time (crossing time) under such a burner. It is therefore contemplated that for extended residence times, several successive burners would be necessary. As has been stated, the burners are of the MFB type and comprise a gas mixing system 10 (fuel 9/oxidant 11) and a ventilation system 13, particularly for ensuring the fume evacuation.

Advantageously, the tunnel furnace is thermally insulated in order to avoid thermal losses and burning hazards. The facility, more particularly the thermal control system and, optionally, the forwarding speed of the conveyor belt are set according to the requirements and controlled by an electronic control facility connected with thermal probes (not shown). The furnace of the MFB type comprises a gas feeding system receiving an ideal gas/air mixture and comprises a distributing plate dividing the gas mixture on a fibre membrane.

The fact that in burners of such a type the shape and size of the flame do not depend on the supplied thermal power is particularly favourable. Indeed, the burner heads can be arranged at a constant height in the furnace and it is possible to control the power of the various heads on the path of the meat foodstuffs circulating in the furnace according to the requirements.

Advantageously, according to a further feature of the invention, setting the power of the various burner heads along the path of the meat foodstuffs in the tunnel furnace can be managed by an electronic control facility, so as to be able to easily modify the thermal processing of the meat foodstuffs according to their nature. Thermal probes arranged along the path allows to control, and if necessary, to instruct a local modification of the temperature according to a programme to be followed.

In most applications, the burner heads are arranged on top of the conveyor belt, but other, optionally complementary, arrangements can perfectly be contemplated, for example side or underlying arrangements.

Meat foodstuffs are understood to mean foodstuffs or food preparations containing at least 50% meat (muscles, fat or giblets) of animal origin, more particularly from bovine, porcine, poultry, fish origin and similar.

The complement consists of the usual non-meat additives as used in meat butchery (for example breadcrumbs and trimmings) and pork butchery (more particularly the authorised food additives and seasonings).

A decrease of the weight loss can be observed, in particular compared to a conventional electric grilling or infra-red system. Such a weight loss decrease is obviously beneficial for the facility's yield, but also provides other advantages, which will be described hereinafter.

Weight loss decreases can be observed through tests, in which a single product, i.e. small chicken chops, is electrically grilled according to the method of the invention. The differences range from 15 to 30% and the method used maintains and even improves the taste and quality. One of the most important effects associated to the lack of weight loss is, however, observed as to the taste. Such improvements were confirmed by a control group of consumers subjected to organoleptic tests with chicken breast. The observed advantages are indicated as compared with conventional products subjected to electric grilling.

It can in particular be observed that the product's color is considered as more attractive as to its even and homogeneous distribution. There are fewer irregularities, i.e. a lack of local “grilled” appearance, than in the cases of the conventional product. The sapidity is also considered as being more favourable; the product is described as less dry and more “flavoursome” as compared with the electrically grilled product.

The product's texture is recognized as being less tough as compared with conventional products, and as being less “filamentous”.

The global evaluation resulting from the consumers being questioned clearly indicates that the product according to the invention is considered as more attractive regarding the taste and that it is clearly preferred.

Additionally, the product's advantages from the nutritional point of view should also be noticed. Laboratory experiments indicate that a very quick heating at high temperatures of the product surface (in this case, hamburgers) results in less damage of the nutritional components (proteins, essential amino acids and vitamins). In addition, less polycyclic aromatic compounds the cariogenic effect of which is feared are formed when using the technique of the invention.

1. A method for continuously cooking meat foodstuffs, wherein said meat foodstuffs (5) are conveyed in a tunnel furnace (1) on a conveyor belt (3) or on conveying rolls or rollers, wherein the meat foodstuffs are subjected to the action of a metallic fibre membrane burner of the MFB type (7).

2. A method according to claim 1, wherein the temperatures are set along the whole path in the tunnel furnace, so as to be able to seal, grill, roast or medium cook according to the requirements and in an adequate chronological order according to industrial requirements.

3. A facility for implementing the method according to claim 1, wherein it essentially comprises a tunnel furnace (1) equipped with a conveyor belt (3) or the like, provided with an inlet for the foodstuffs (3) to be cooked at the front and, at the back, with an outlet for such foodstuffs after cooking, such a tunnel furnace (1) being equipped with at least one burner (7) and preferably several successive burners of the MFB type equipped with a thermal control.

4. A facility according to claim 3, wherein the conveyor belt (3) circulates at a constant speed and the residence at a temperature as imposed by a burner (7) is set by the residence time (crossing time) under said burner.

5. A facility according to claim 3, wherein, several successive burners are provided for extended residence times.

6. A facility according to claim 3, wherein the burners (7) are of the MFB type and comprise a gas mixing system (10) (fuel (9)/oxidant (11)) and a ventilation system (13) in order to ensure the fume evacuation.

7. A facility according to claim 3, wherein the tunnel furnace (1) is thermally insulated in order to avoid thermal losses and burning hazards.

8. A facility according to claim 3, wherein the thermal control system and the forward speed of the conveyor belt are set according to the requirements and are controlled by an electronic control facility

9. A facility according to claim 3, wherein the furnace of the MFB type comprises a gas feeding system receiving an ideal gas/air mixture and comprises a distributing plate dividing the gas mixture on a fibre membrane.

10. A facility according to claim 3, wherein the burner heads are arranged at a constant height in the furnace and the power of the various heads is controlled according to the requirements on the path of the meat foodstuffs circulating in the furnace.

11. A facility according to claim 3, wherein setting the power of the various burner heads along the path of the meat foodstuffs in the tunnel furnace is managed by an electronic control facility, so as to be able to easily modify the thermal processing of the meat foodstuffs according to their nature.

12. A facility according to claim 3, wherein thermal probes arranged along the path is used for controlling and, if necessary, instructing a local modification of the temperature according to a programme to be followed.

13. A facility according to claim 3, wherein the burner heads are arranged above, laterally and/or under the conveyor belt.

14. Use of the method for continuously cooking meat foodstuffs, wherein said meat foodstuffs (5) are conveyed in a tunnel furnace (1) on a conveyor belt (3) or on conveying rolls or rollers, wherein the meat foodstuffs are subjected to the action of a metallic fibre membrane burner of the MFB type (7), or of the facility according to claim 3, wherein the food preparations contain at least 50% meat (muscles, fat or giblets) from animal origin, more particularly from bovine, porcine, poultry, fish origin or similar, the complement consisting in the usual non-meat additives as used in meat butchery (for example breadcrumbs and trimmings) and in pork butchery (more particularly the authorised food additives and seasonings).
